(19) United States
(12) Patent Application Publication
(10) Pub. No.: US 2004/0008733 A1
(43) Pub. Date: Jan. 15, 2004

(54) Multiplexer input circuit with DLL phase detector

(76) Inventor: Berthold Wedding, Korntal-Munchingen (DE)

Correspondence Address: SUGHRUE MION, PLLC, 2100 PENNSYLVANIA AVENUE, N.W., WASHINGTON, DC, 20037, US

(21) Appl. No.: 10/602,653

(22) Filed: Jun. 25, 2003

(30) Foreign Application Priority Data
Jul. 12, 2002 (EP) 02 360 209.7

(51) Int. Cl. H04J 3/06

(52) U.S. Cl. 370/518; 370/522

(57) ABSTRACT

An input circuit, in particular for a multiplexer, for phase controlling of a data input signal with a clock signal, comprises a flip-flop, wherein the data signal is fed to a clock input of the flip-flop and the clock signal is fed to the data input of the flip-flop, and wherein the data output of the flip-flop is used as a control signal of a locked loop. An advantage of the invention is, that it is of simple design which makes the invention especially useful for high frequencies. The data output of the flip-flop is dependent on the phase relationship of the data input signal with respect to the clock signal.

The invention is based on a priority application EP 02360209.7 which is hereby incorporated by reference.

### BACKGROUND OF THE INVENTION

For exactly controlling the switching of a multiplexer to the inputs of which digital signals to be multiplexed are fed, especially at frequencies of 10 GHz or higher, it is necessary to have a clock for controlling the multiplexer or for controlling another device, for example a device for pulse shaping, which clock is in an exact relationship to the input signals to be multiplexed or pulse shaped. One has to consider, that the phase relationship of the input signals to a clock signal available in an apparatus or circuitry which a multiplexer or other devices arranged, is not known. It is an object of the invention, to provide an arrangement and method which makes sure that the phase relationship between the input data signal and a clock signal for controlling the multiplexer or other device has the desired value.

### SUMMARY OF THE INVENTION

This object is achieved in a first aspect of the invention in that an input circuit, in particular for a multiplexer, for phase controlling of a data input signal with a clock signal, comprises a flip-flop, wherein the data signal is fed to a clock input of the flip-flop and the clock signal is fed to the data input of the flip-flop, and wherein the data output of the flip-flop is used as a control signal of a locked loop.

Though the phase relationship is originally unknown, the invention presumes, that the clock frequency of the input data signals is known. The value of the clock frequency of the input data signal may be clearly defined in the design of the telecommunications system or apparatus, or said frequency is known from a measurement. In the following description, it is further assumed that for the proper function of the described devices and methods, it is necessary, that the clock frequency of the data input signals and of the for example locally produced clock signal is the same; however, dependent on the special constructions of devices used for the data sources, for the multiplexer or pulse shaping, it may be that such devices require a clock frequency higher or lower than the bit frequency of the input data signals.

An advantage of the invention is, that it is of simple design which makes the invention especially useful for high frequencies as mentioned above. The data output of the flip-flop is dependent on the phase relationship of the data input signal with respect to the clock signal.

The locked loop controlled by the output signal of the flip-flop is in the described examples a delay locked loop (DLL). However the invention takes into account, that in some cases instead of a DLL a PLL (phase locked loop) may be used. In embodiments of the invention, the DLL is made by inserting a controllable phase shifter into the path of clock signals of a local clock generator or a local clock signal source, wherein the control signals of the DLL are fed to a control input of the controllable phase shifter.

The flip-flop may be of any usable construction. In embodiments of the invention described, a D-flip-flop is used for the flip-flop. The D-flip-flop at the occurrence of a first edge of the signal provided to a clock input of the D-flip-flop stores the value of a signal at a data input of the D-flip-flop. On the occurrence of the next edge of the signal fed to the clock input, the stored value is delivered to an output terminal of the D-flip-flop. In variants, the arrangement may be such that more than two edges of the signal fed to the clock input are necessary in order to “transport” the signal of the data input of the D-flip-flop to the output terminal. This is for example the case, when the so-called master slave flip-flop design is provided.

The invention as defined in claim one and referred to above allows different manners of realisation.

In embodiments of the invention, the input circuit comprises a further flip-flop (DFF1), wherein the data signal is fed to a data input of the further flip-flop and the clock signal is fed to the clock input of the further flip-flop.

This embodiment is of advantage when a single data signal has to be brought into proper phase relationship with a local clock signal, which single signal comes from a data source which is not controlled by a master clock which also controls the multiplexer or pulse shaping device mentioned above. This embodiment is also usable when the further flip-flop is used only for pulse shaping.

In an embodiment of the invention the data input signal is, in use, provided by output data of a data source, wherein the data source is arranged to control the phase of the output data in dependence of an adjusting signal which is input to the data source, wherein the locked loop delivers the adjusting signal to the data source.

This embodiment is useful, when the data source or data sources from which the data input signal or signals come, is provided with clock signals from a master clock generator which also provides the apparatus of the invention with clock signals. Since normally each data source of digital signals requires a clock signal, this embodiment can be used in such cases where the data source is located in a distance from the local clock generator which distance allows providing the clock signals of the master clock generator to the data source. The data source in this case is part of the locked loop or feedback control arrangement. The phase position of the data signals provided by the data source is adjusted by the clock signals delivered to the data source.

In an embodiment of the invention, the locked loop is arranged to adjust the phase of the clock signal which is provided to the clock input of the further flip-flop.

In this case, the flip-flop in the data path is used for adjusting the phase. It is not necessary that the clock signal fed to the data input of that flip-flop which provides the control output signal is also adjusted in phase.

In an embodiment of the invention the locked loop is arranged to adjust the phase of the clock signal which is provided to the data input of the flip-flop.

This embodiment may be used in cases where the data source cannot be controlled in phase with a clock signal derived from a master clock signal of the present inventive device by phase shifting.

In an embodiment of the invention the locked loop comprises a controllable phase shifter (thus being a delay locked loop) and is arranged to adjust the phase of the clock signal which is provided to the data input of the flip-flop.

This is the embodiment discussed immediately before, provided in addition with a phase shifter and provides therefore a DLL.

In an embodiment of the invention, the multiplexer has a plurality of data input terminals to be provided with data signals, a data output and a clock input, wherein a said data signal is fed to a clock input of the flip-flop and the clock signal is fed to the clock input of the multiplexer.

In this embodiment, the further flip-flop mentioned further above is not provided. The multiplexer may work in addition to its multiplexing function as a pulse shaping device. Such pulse shaping is often a normal function of multiplexers. Nevertheless, especially in the field of bit frequencies mentioned above (10 Gbit/s or higher) the special pulse forming devices (for example flip-flops) are often preferred.

In such case, such a pulse forming device may be followed by a multiplexer, as is the case in an embodiment of the invention, in which the multiplexer has a plurality of data inputs to be provided with data signals, a data output and a clock input, wherein a number of further flip-flops for a plurality of data signals is provided, which number corresponds to the number of data inputs of the multiplexer, and the clock input of the multiplexer is provided with a clock signal.

The invention also concerns a method which performs the steps discussed above, such method for phase controlling of the data signal with a clock signal comprises: scanning the clock signal with an edge of the data signal, deriving from the scanning result a control signal, using the control signal for adjusting the phase relationship between the data signal and the clock signal.

Advantages of the method correspond to advantages mentioned above.

### BRIEF DESCRIPTION OF THE DRAWINGS

Further features and advantages of the invention will be apparent from the following description of preferred variants and embodiments of the invention in connection with the drawings which show features essential for the invention, and in connection with the claims. The individual features may be realised individually or in any combination in an embodiment of the invention.

FIG. 1 is a block diagram of a basic circuit of the invention.

FIG. 2 is a block diagram of an embodiment for adjusting the phase for one digital signal.

FIG. 3 is a block diagram of an embodiment for adjusting the phase of digital signals of two data sources.

FIG. 4 is the principle of a multiplexer 4:1.

FIG. 5 is a time diagram of a clock signal and a data signal.

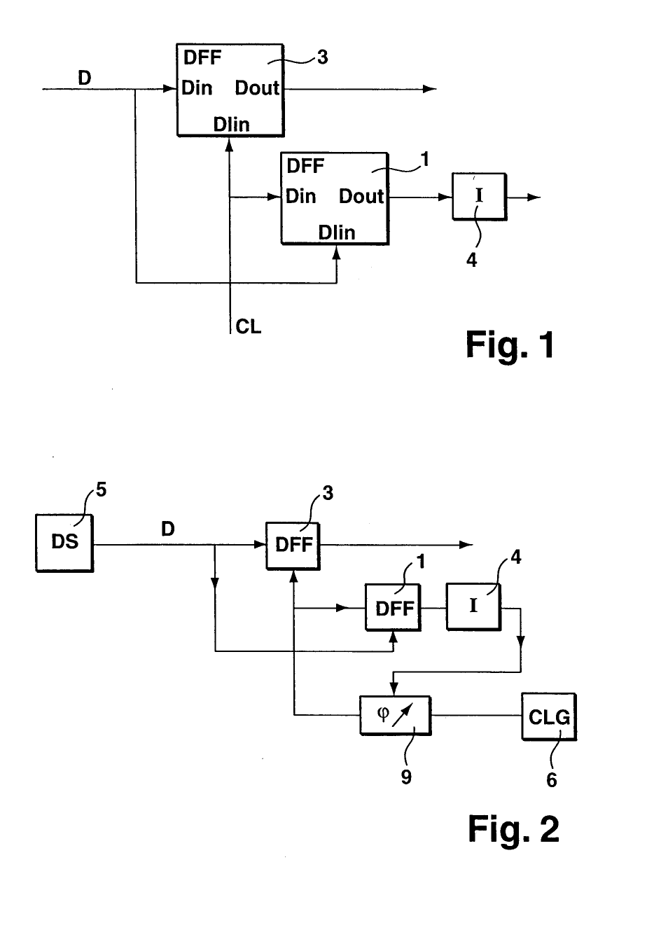

In FIG. 1 a flip-flop 1 and a further flip-flop 3 are provided. The flip-flop are D-flip-flops in the example end, therefore, designated with the letters DFF. Each of the flip-flops has a data input terminal Din and an output terminal Dout, and further a clock input terminal Clin. A data input signal D is fed to the data input of the further flip-flop 3 and to the clock input of the flip-flop 1. A clock signal CL is fed to the clock input of the further flip-flop 3 and to the data input of the flip-flop 1.

The output terminal of the flip-flop 1 is connected to an integrator (I) 5. In the circuitry of FIG. 1 the flip-flop 1 performs scanning of the clock signal CL by the data signal. The result is a wave form having a D.C. voltage content. The value of the D.C. voltage content is dependent on the phase relationship between the clock signal and the data signal. The integrator 5 delivers at its output this D.C. voltage, which in the embodiments of the invention is used as control signal.

In FIG. 1, the phase relationship between the data signal and the clock signal is determined only by the flip-flop 1. Therefore, for this function, the flip-flop 3 is not necessary. In FIG. 1, the flip-flop 3 may serve for pulse shaping of the data signal.

FIG. 2 comprises the elements shown in FIG. 1 and further elements. A data source 5 delivers the digital data D. A master clock generator 7 delivers a clock signal to the input of an adjustable phase shifter 9. The output signal of the integrator 5 is connected to a control input of the phase shifter 9. The output of the phase shifter 9 delivers the clock signal CL to the flip-flops 1 and 3. Though the data source 5 for its correct will be provided with a clock signal, it is not coupled to the master clock generator 7 of FIG. 2. The circuitry of FIG. 2 is arranged such that the clock signal delivered to the clock input of the flip-flop 3 is in such phase relationship with respect to the digital data that for pulse shaping digital signal is switched through by the flip-flop 3 in such a way that the pulse form is not deteriorated.

The circuitry of FIG. 2 performs a closed loop control. In this embodiment, it is a locked loop. Because of the presence of the phase shifter 9, it is a delay locked loop (DLL). The data source 5 is not part of the control loop.

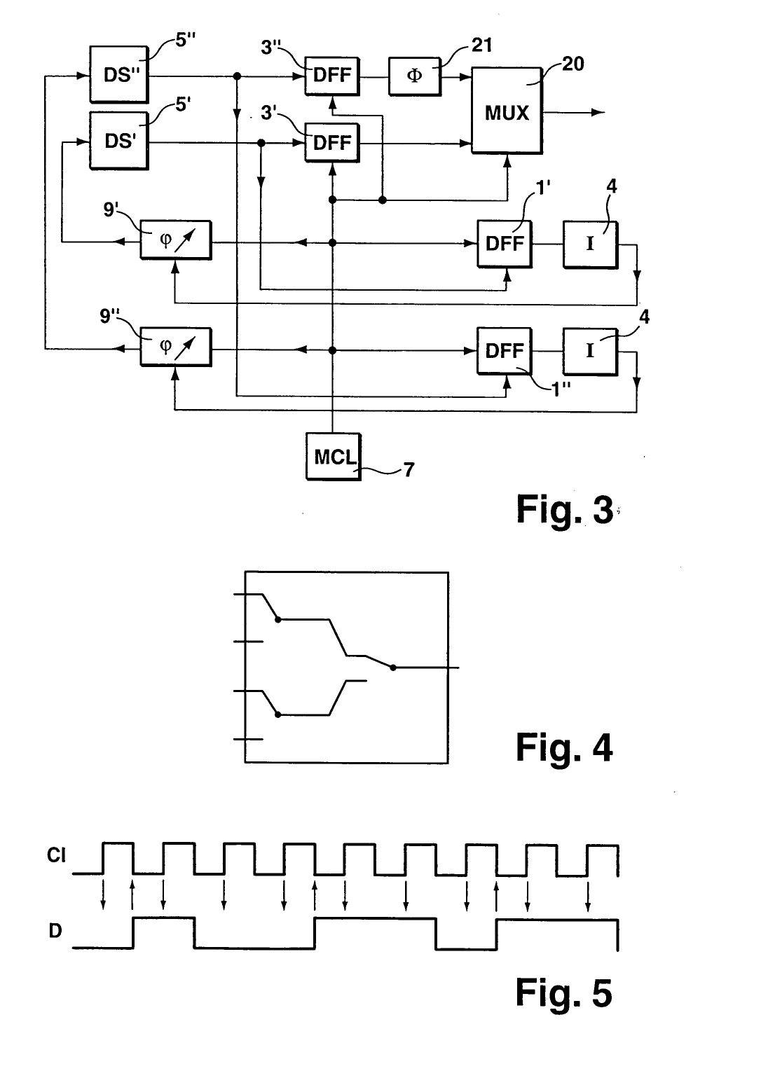

In the embodiment of FIG. 3, in comparison with FIG. 2 certain elements are provided in duplicate. Further, additional elements are provided. There are provided two data sources 5′ and 5″, to flip-flops 1′ and 1″, and two further flip-flops 3′ and 3″. The flip-flops 1′ and 3′ are provided with a clock signal from the master clock generator 7 directly. The flip-flops 1″ and 3″ are provided with the clock signals over a fixed phase delay 19′ and 19″. The data sources 5′ and 5″ are provided with clock signals which stem from the master clock generator 7. The master clock generator 7 is connected to clock inputs of the data sources via adjustable phase shifters 9′ and 9″. The control inputs of those phase shifters are, as in FIG. 2, connected with outputs of integrator, which are connected to the outputs of the flip-flops 1′ and 1″. In this embodiment, the data sources 5′ and 5″ are part of the closed loop control. The further flip-flops 3′ and 3″ serve for pulse shaping only. Their output signals are connected to input terminals of a multiplexer 20. In order to make sure the, that the output signals of the further flip-flops 3′ and 3″ arrive at the multiplexer 20 at different times, the fixed phase shifter 19′ is provided. It is also necessitate and that the data source 5″ is controlled such that it delivers its data signals in synchronism with the required time of arrival at the multiplexer 20. For this purpose, the fixed phase shifter 19″ is provided which is inserted between the master clock generator 7 and the data input terminal of the flip-flop 1″. The two fixed phase shifters 19′ and 19″ perform the same phase shift or time delay and in the same direction.

In the example of FIG. 3, the data sources deliver the data signals at the speed of about 10 Gbps. The multiplexer 20 combines the two signals to a combined signal having a frequency of about 20 Gbps.

FIG. 4 shows the known principle of a 4:1 multiplexer. It comprises three switching elements each connecting two input signals to one output. The rightmost switching element in FIG. 1 normally is that which has the highest switching speed.

FIG. 5 shows a time diagram of the clock signal which has generally the form of a sinus wave, and of the data signal D. When in the flip-flop 1 of FIGS. 1 and 2 when in the flip-flops 1′ and 1″ in FIG. 3 scanning of the clock signal by the data signal is made, the phase relationship between the clock signal and the data signal is adjusted such that the clock signal is scanned near its maximum value. This is indicated by a dashed line designated with the letter T. In this case, the best quality of scanning is achieved.

In this timing diagram of FIG. 5, the relative phases of the clock signal and data signal are shown. The arrows indicate the instants of sampling operations in the data flip-flop 3 (arrow downwards) and in the phase detector flip-flop 1 (arrow upwards).

The flip-flops sample the input signals at the data input at a positive transition of the signal at the clock input. Thus the data flip flop (3 in FIG. 1) samples the incoming data signal in the middle of the symbol pulses (see downward arrows in FIG. 5). The phase detector flip flop (1 in FIG. 1) samples the incoming clock signal at the negative clock transitions (see upward arrows in FIG. 5). If the clock signal arrives early, DFF 1 generates a “low” output signal. If the clock signal arrives late, DFF 1 generates a “high” output signal.

In order to simplify the description, in the description of FIG. 3 only a multiplexer 2:1 is mentioned. However, the invention also aims to create a circuitry adapted for a multiplexer 4:1, which combines four signals each having a frequency of about 10 Gbps to a combined data signal having about 40 Gbps. For this purpose, the circuitry shown in FIG. 3 has to be amended in order to provide a multiplexer 4:1 with input signals which have the correct time sequence with respect to one another.

1. Input circuit, in particular for a multiplexer, for phase controlling of a data input signal with a clock signal, comprising a flip-flop, wherein the data signal is fed to a clock input of the flip-flop and the clock signal is fed to the data input of the flip-flop, and wherein the data output of the flip-flop is used as a control signal of a locked loop.

2. Input circuit according to claim 1, comprising a further flip-flop, wherein the data signal is fed to a data input of the further flip-flop and the clock signal is fed to the clock input of the further flip-flop.

3. Input circuit according to claim 1, the data input signal being, in use, provided by output data of a data source, wherein the data source is arranged to control the phase of the output data in dependence of an adjusting signal which is input to the data source, wherein the locked loop delivers the adjusting signal to the data source.

4. Input circuit according to claim 2, wherein the locked loop is arranged to adjust the phase of the clock signal which is provided to the clock input of the further flip-flop.

5. Input circuit according to claim 4, wherein the locked loop is arranged to adjust the phase of the clock signal which is provided to the data input of the flip-flop.

6. Input circuit according to claim 4, wherein the locked loop comprises a controllable phase shifter (thus being a delay locked loop) and is arranged to adjust the phase of the clock signal which is provided to the data input of the flip-flop.

7. Multiplexer with an input circuit according to claim 1, the multiplexer having a plurality of data inputs to be provided with data signals, a data output and a clock input, wherein a said data signal is fed to a clock input of the flip-flop and the clock signal is fed to the clock input of the multiplexer.

8. Multiplexer with an input circuit according to claim 2, the multiplexer having a plurality of data inputs to be provided with data signals, a data output and a clock input, wherein a number of further flip-flops for a plurality of data signals is provided, which number corresponds to the number of data inputs of the multiplexer, and the clock input of the multiplexer is provided with a clock signal.

9. Method for phase controlling of a data signal with a clock signal comprising: scanning the clock signal with an edge of the data signal, deriving from the scanning result a control signal, using the control signal for adjusting the phase relationship between the data signal and the clock signal.
